(19) United States
(12) Patent Application Publication
(10) Pub. No.: US 2005/0231087 A1
(43) Pub. Date: Oct. 20, 2005

(54) Direct backlight module and liquid crystal display utilizing the same

(76) Inventors: Yun-Liang Huang, Taipei City (TW); Hsin-Kuo Chang, Kaohsiung City (TW); Hsin-Jou Chiu, Longtan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/919,871

(22) Filed: Aug. 17, 2004

(30) Foreign Application Priority Data
Apr. 15, 2004 (TW) 93110475

(51) Int. Cl. H01K 1/18

(52) U.S. Cl. 313/292

(57) ABSTRACT

A direct backlight module and liquid crystal display utilizing the same. The direct backlight module comprises a reflector, at least one light source, and a plurality of transparent supports. The reflector has an opening, and the light source is disposed parallel to the reflector. The transparent supports are disposed at each end of the light source to secure the light source. Thus, light emitted from the light source can be reflected by the reflector.

### BACKGROUND

The present invention relates to a direct backlight module and a liquid crystal display utilizing the same.

Generally, an LCD comprises a liquid crystal panel and a backlight module. The liquid crystal panel is the display of the LCD. Since the liquid crystal panel does not emit light, a light source providing sufficient brightness and uniform distribution is required to properly display images. A backlight module serves as the light source for the LCD. Further, a frame is applied to enclose the backlight module and the liquid crystal panel for protection of the LCD elements.

Generally, backlight modules can be categorized as direct and edge structures. In edge backlight modules, the light source is disposed on a side of the backlight module to reduce volume thereof, and a light guide plate guides the light toward the liquid crystal panel. Light distribution via the light guide plate is, however, typically non-uniform.

In direct backlight modules the light source is disposed directly in the cavity of the backlight module, thus occupying a relatively large volume thereof. Besides, more than one lamp can be employed to enhance light emission, and provide more uniform light distribution.

FIG. 1 is a perspective view showing a conventional direct backlight module. In FIG. 1, the backlight module comprises a reflector 10, a light diffusing plate 20, at least one lamp serving as light source 30, and a plurality of supports 40 supporting the light source 30. Further, a plurality of optical films, such as a prism film or a protective diffusing plate, can be employed in the direct backlight module to enhance light usage or diffusion rate. The optical film is not shown in FIG. 1, hence detailed description thereof is omitted herein.

The reflector 10 is a U-shaped plate with an inner surface having high reflectivity, and comprises an opening for emitting light to the upper side of the backlight module shown in FIG. 1. The light diffusing plate 20 is disposed in the opening of the reflector 10 parallel to the bottom surface thereof for diffusing light. The light source 30, which comprises one or more lamps, is disposed in parallel at the bottom of the reflector 10 for emitting light. In the conventional direct backlight module, a cold cathode fluorescent lamp (CCFL) is typically employed as the light source 30. The CCFL comprises a fluorescent tube with electrodes disposed at opposing ends therein for emitting light when power is applied to the electrodes.

Further, the supports 40 are disposed perpendicular to the reflector 10 at each end of the light source 30. Thus, the supports 40 fix the light source 30 to the reflector 10 and absorb shock from external force or impact. However, the perpendicular supports 40 block light emitted from each end of the light source 30. Light emission efficiency in the areas directly above the supports 40 in FIG. 1 is significantly reduced. Further, in an LCD using the conventional direct backlight module, brightness distribution deteriorates due to shadow areas generated by the supports 40, thus causing dark spots on the LCD panel.

In order to eliminate shadows created by the supports, another conventional direct backlight module is disclosed in Japanese Patent Publication JP 11-329040, which is shown in FIG. 2. The direct backlight module in FIG. 2 comprises a reflector 10, a light diffusing plate 20, at least one lamp serving as the light source 30, and a plurality of supports 40, similar to the structure shown in FIG. 1. The supports 40 in FIG. 2, however, are not perpendicular to the reflector 10. Instead, the supports 40 are respectively formed with an inclination θ, which ranges from 50 to 70 degrees for example, in relation to the reflector 10 in FIG. 2. Further, the supports 40 are white highly reflective materials, such as polycarbonate, to increase reflectivity and light emission efficiency. In this case, the size of the backlight module is reduced and the light source 30 consumes less power.

In the conventional direct backlight module shown in FIG. 2, however, the white highly reflective materials used for the supports 40 are opaque. Thus, even though the light efficiency is enhanced due to the increased reflectivity of the supports 40, light emitted from the light source 30 is still blocked thereby causing dark spots on the LCD panel.

### SUMMARY

Accordingly, an object of the present invention is to provide a direct backlight module comprising a light source with enhanced light emission efficiency.

Another object of the present invention is to provide a liquid crystal display employing the disclosed direct backlight module to eliminate the shadows caused by the described supports.

The present invention discloses a direct backlight module, comprising a reflector, at least one light source, and a plurality of transparent supports. The reflector comprises an opening, wherein the light source is disposed parallel to the bottom surface thereof. The transparent supports are disposed at each end of the light source. Thus, light emitted from each end of the light source can be efficiently reflected by the reflector to maximize brightness over the entire liquid crystal display.

Further, the present invention discloses a liquid crystal display, comprising a liquid crystal panel and the aforementioned direct backlight module. Additionally, a frame covering the liquid crystal panel and the direct backlight module can be provided to protect the liquid crystal display.

In the present invention, the light source can be a cold cathode fluorescent lamp (CCFL), or an external electrode fluorescent lamp (EEFL).

A detailed description is given in the following embodiments with reference to the accompanying drawings.

### BRIEF DESCRIPTION OF THE DRAWINGS

The present invention can be more fully understood by the subsequent detailed description and examples with references to the accompanying drawings, wherein:

FIG. 1 is a schematic view of a conventional direct backlight module;

FIG. 2 is a schematic view of another conventional direct backlight module;

FIG. 3 is a schematic view of an embodiment of the direct backlight module of the present invention;

FIG. 4 is a schematic view of another embodiment of the direct backlight module of the present invention; and

FIG. 5 is a schematic view of a further embodiment of the direct backlight module of the present invention.

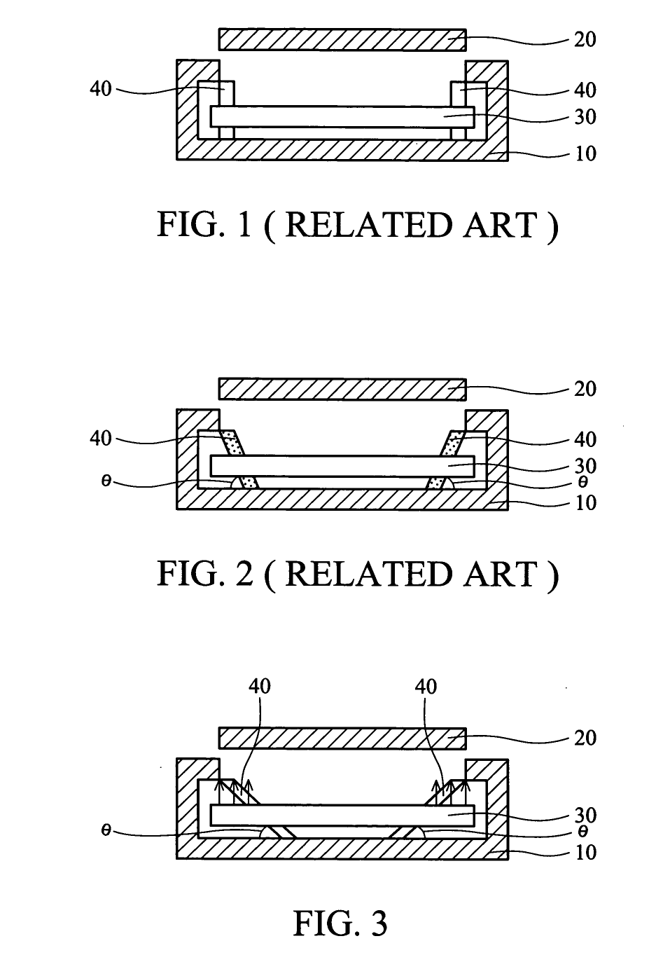

### DETAILED DESCRIPTION OF THE INVENTION

The present invention relates to a direct backlight module and a liquid crystal display utilizing the same. An embodiment of the present invention is described hereinafter with reference to FIG. 3. It should be noted that the present invention is not limited by the embodiment.

FIG. 3 shows an embodiment of the direct backlight module of the present invention. In FIG. 3, the backlight module comprises a reflector 10, a light diffusing plate 20, at least one lamp serving as the light source 30, and a plurality of transparent supports 40 supporting the light source 30. Further, a plurality of additional optical films (not shown), e.g. a prism film or a protective diffusing plate, can be employed in the direct backlight module to enhance light usage or diffusion rate.

The reflector 10 has a highly reflective inner surface and an opening for allowing emitted light to reach the upper side of FIG. 3. The light diffusing plate 20 is disposed in the opening parallel to the reflector 10 for diffusing the light. The light source 30, which can be one or more lamps, is disposed parallel to the reflector 10. The cold cathode fluorescent lamp (CCFL) is employed as the light source 30. The CCFL comprises electrodes disposed at opposing ends inside of a fluorescent tube for emitting light when power is supplied thereto.

Further, the transparent supports 40 of the backlight module shown in FIG. 3 comprise transparent materials. Thus, a large portion of light emitted from each end of the light source 30 can pass through the transparent supports 40, thus significantly increase the light emission efficiency of the backlight module. The transparent supports 40 can be disposed perpendicular to the reflector 10, or inclined in relation to the reflector 10 to reduce the thickness of the backlight module.

The direct backlight module shown in FIG. 3 can be employed in a liquid crystal display. A liquid crystal panel is provided and disposed at the opening of the reflector 10, and a frame or a bezel is provided to cover the liquid crystal panel and the direct backlight module. Thus, the shadows generated by the conventional supports are eliminated, and enhanced brightness with uniform distribution is obtained.

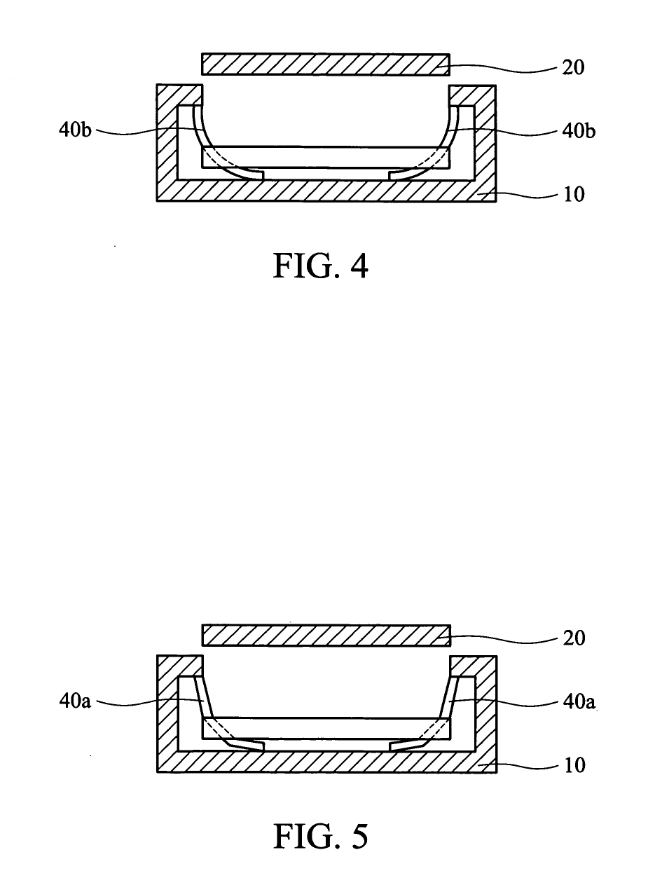

The transparent supports 40 can be fabricated in a variety of shapes. For example, each transparent support 40 in FIG. 3 is straight. In another embodiment as shown in FIG. 4, each transparent support 40b is curved. In a further embodiment as shown in FIG. 5, each transparent support 40a is segmented.

The present invention employs transparent supports in the direct backlight module. Thus, light emission efficiency of the light source is enhanced, and brightness with uniform distribution can be obtained. Further, the length of the light source can be shortened due to the increased light emission efficiency of the light source. Accordingly, the size of the backlight module is reduced, which is preferable for portable devices such as notebook computers, PDAs and the like.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A direct backlight module, comprising:
a reflector having an opening;
at least one light source disposed parallel to the reflector, each of the light source having two ends; and
a plurality of transparent supports disposed at each of the ends of the light source to secure the light source.

2. The direct backlight module as claimed in claim 1, wherein each of the transparent supports is straight.

3 The direct backlight module as claimed in claim 1, wherein each of the transparent supports is curved.

4. The direct backlight module as claimed in claim 1, wherein each of the transparent supports is segmented.

5. The direct backlight module as claimed in claim 1, wherein the light source is a cold cathode fluorescent lamp (CCFL).

6. A liquid crystal display, comprising:
a liquid crystal panel; and
a direct backlight module, comprising:
a reflector having an opening toward the liquid crystal panel;
at least one light source disposed parallel to the reflector, each of the light source having two ends; and
a plurality of transparent supports disposed at each of the ends of the light source to secure the light source.

7. The liquid crystal display as claimed in claim 6, wherein each of the transparent supports is straight.

8. The liquid crystal display as claimed in claim 6, wherein each of the transparent supports is curved.

9. The liquid crystal display as claimed in claim 6, wherein each of the transparent supports is segmented.

10. The liquid crystal display as claimed in claim 6, further comprising a frame surrounding the liquid crystal panel and the direct backlight module.

11. The liquid crystal display as claimed in claim 6, wherein the light source is a cold cathode fluorescent lamp (CCFL).
